(19) United States
(12) Patent Application Publication
(10) Pub. No.: US 2026/0328299 A1
(43) Pub. Date: Oct. 22, 2026

(54) Battery Drain Valve

(71) Applicant: Illinois Tool Works Inc., Glenview, IL (US)

(72) Inventor: Mark O. Lepper, Oak Park, IL (US)

(21) Appl. No.: 19/648,549

(22) Filed: Apr. 15, 2026

Related U.S. Application Data
(60) Provisional application No. 63/792,419, filed on Apr. 22, 2025.

(51) Int. Cl. F16K 15/03; F16K 24/04; F16K 27/02

(52) U.S. Cl. CPC F16K 15/034; F16K 24/04; F16K 27/0209

(57) ABSTRACT

A valve assembly is provided for facilitating one-way fluid flow through an opening in a component. The valve assembly includes a valve housing defining a passageway, a seal element disposed about at least a portion of the valve housing, a flapper coupled to the valve housing and movable relative thereto to selectively permit fluid flow through the passageway, and a cap coupled to the valve housing. The cap is configured to at least partially enclose the valve housing and the flapper while permitting fluid flow through one or more openings formed therein. The cap is removably coupled to the valve housing via one or more cap-locking tabs extending from the valve housing that engage corresponding features defined in the cap, thereby securing the cap to the valve housing.

### CROSS-REFERENCE

The present application claims priority to United States Provisional Patent Application No. 63/792,419, filed Apr. 22, 2025, and entitled “Battery Drain Valve,” which is hereby incorporated by reference in its entirety.

### BACKGROUND

The electric drive components in electric vehicles (EVs) and hybrid-electric vehicles (HEVs), such as the motor, battery, and power electronics, present unique challenges for associated hardware, including fasteners and functional components such as valves. EV and HEV battery systems commonly incorporate one or more valves, such as drainage or venting valves, to manage the release of fluids and/or gases within the battery pack or associated systems.

Such valves serve several functions, including thermal management, pressure regulation, safety venting, and facilitating maintenance and servicing operations. During operation and charging, for example, EV batteries generate heat and may rely on liquid cooling systems to maintain acceptable temperatures. Valves can enable controlled drainage or replacement of coolant during servicing or in the event of leakage. Additionally, under certain fault conditions, such as thermal runaway or internal damage, batteries may release gases or fluids. Valves provide a mechanism for safely venting such substances, thereby reducing pressure build-up and mitigating the risk of damage, fire, or explosion. Valves may also allow for the drainage of unwanted water ingress into the battery enclosure.

While existing valve assemblies provide fluid control functionality, they may be susceptible to damage, contamination, or obstruction during operation or over the lifetime of the vehicle. For example, exposure to debris, mechanical impact, or environmental conditions can impair valve performance and reliability.

Accordingly, there remains a need for an improved valve assembly that enhances durability and operational reliability. In particular, a valve incorporating protective features, such as a cap or cover, may help shield the valve from damage and blockage.

### SUMMARY

The present disclosure relates generally to a valve assembly to drain fluid from a volume, such as automotive battery housings and assemblies, substantially as illustrated by and described in connection with at least one of the figures, as set forth more completely in the claims. More specifically, the present disclosure relates generally to a drainage valve assembly for us in, inter alia, EVs.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a first perspective assembly view of an example drainage valve system having a valve assembly in accordance with aspects of this disclosure.

FIG. 1b illustrates a perspective assembled view of the example drainage valve system with the valve assembly.

FIG. 1c illustrates a second perspective assembly view of the example drainage valve system having the valve assembly.

FIG. 1d illustrates a perspective cross-sectional view of the example drainage valve system taken along cut line A-A (FIG. 1c).

FIG. 2a illustrates a perspective assembly view of the valve assembly with the cap separated from the valve body assembly.

FIG. 2b illustrates a perspective assembly view of the valve body assembly having a valve housing, an annular seal, and a flapper.

FIG. 2c illustrates a cross-sectional assembly view of the valve assembly along cut line B-B (FIG. 2a) with the cap and flapper separated from the valve housing.

FIG. 2d illustrates a cross-sectional assembly view of the valve assembly along cut line B-B (FIG. 2a) with the cap separated from the valve body assembly.

FIG. 2e illustrates a cross-sectional assembled view of the valve assembly along cut line B-B (FIG. 2a).

FIGS. 3a-3d illustrate, respectively, perspective, side elevation, top plan, and bottom plan views of the cap of the valve assembly.

FIGS. 4a-4d illustrate, respectively, perspective, side elevation, top plan, and bottom plan views of the valve housing of the valve assembly.

FIGS. 5a-5d illustrate, respectively, perspective, side elevation, top plan, and bottom plan views of the annular seal of the valve assembly.

FIGS. 6a-6d illustrate, respectively, perspective, side elevation, top plan, and bottom plan views of the flapper of the valve assembly.

FIG. 7 is a perspective view of a high-flow cap with an outer protection face, in which a plurality of windows are distributed about a perimeter sidewall.

FIG. 8 is a perspective view of a flow cap with lower sidewall protection, in which a plurality of windows are provided in a perimeter sidewall and a plurality of plates extend upward from a seal wall toward a cap surface.

FIG. 9 is a perspective view of a flow cap with upper sidewall protection, in which a plurality of windows are provided in a perimeter sidewall and a plurality of plates extend downward from a cap surface toward a seal wall.

FIG. 10 is a perspective view of a full sidewall protection cap, in which a perimeter sidewall is substantially solid and a plurality of windows are distributed about a perimeter of a cap surface.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a valve assembly to drain fluid from a volume, such as automotive battery housings and assemblies, more specifically, the present disclosure relates generally to a one-way drainage valve assembly with a cap for us in, inter alia, EVs.

In one example, a valve assembly is provided that includes a valve housing defining a passageway and having a seal element disposed about at least a portion of the valve housing. A flapper is coupled to the valve housing and is movable relative thereto to selectively permit one-way fluid flow through the passageway. The valve assembly further includes a cap coupled to the valve housing, where the cap at least partially encloses the valve housing and the flapper and defines one or more openings to permit fluid flow therethrough. The cap is removably coupled to the valve housing via one or more cap-locking tabs extending from the valve housing, the cap-locking tabs being configured to engage corresponding features of the cap.

In some examples, the cap defines a plurality of fastener openings configured to receive the cap-locking tabs. In some examples, each fastener opening includes a ledge configured to engage a corresponding clip feature of a respective cap-locking tab.

In some examples, the cap further includes a plurality of guide walls positioned adjacent the fastener openings and configured to guide the cap-locking tabs into engagement with the ledges. In some examples, the guide walls define a channel therebetween that is configured to align the cap-locking tabs during assembly.

In some examples, the cap further defines at least one clearance notch adjacent at least one of the fastener openings to facilitate insertion of the cap-locking tabs.

In some examples, the cap includes a cap surface and a plurality of rings extending from the cap surface. In some examples, the plurality of rings are spaced apart from one another to define fluid flow paths through the cap. In some examples, the plurality of rings are interconnected by a plurality of support ribs. In some examples, the cap surface includes a plurality of ribs configured to increase structural rigidity of the cap.

In some examples, the cap further includes a seal wall extending from the cap surface and configured to at least partially cover the seal element. In some examples, the seal wall is configured to shield the seal element from direct exposure to fluid and debris entering through the cap.

In some examples, the cap is configured such that, upon coupling to the valve housing, the cap cooperates with the seal element to form a fluid-tight interface. In some examples, the cap is configured to engage the valve housing such that relative axial movement between the cap and the valve housing is restrained by engagement between the cap-locking tabs and corresponding features of the cap. In some examples, the cap is further configured to engage the valve housing such that relative rotational movement between the cap and the valve housing is restrained.

In some examples, at least one of the cap-locking tabs includes an ingress shield configured to align with a portion of the cap to block an opening formed in the cap. In some examples, the ingress shield is configured to obstruct a clearance notch defined in the cap when the cap is coupled to the valve housing.

In some examples, the cap is configured to be coupled to the valve housing by a snap-fit engagement. In some examples, the cap is configured to be removable from the valve housing without destruction of either component. In some examples, the cap is configured to enclose the valve housing while permitting fluid flow through openings defined between structural elements of the cap.

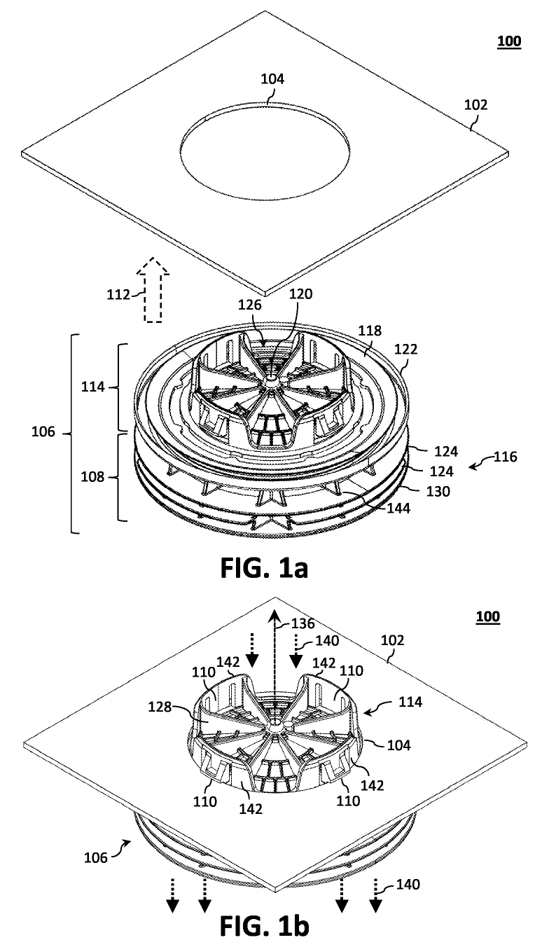

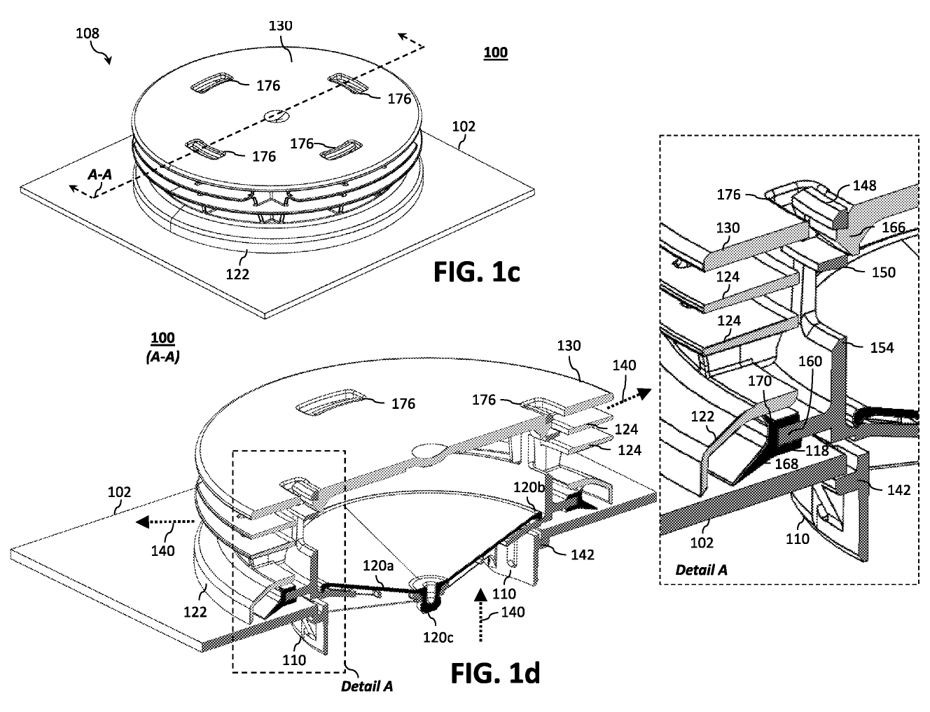

FIGS. 1a and 1b illustrate, respectively, perspective assembly and assembled views of an example drainage valve system 100 having a valve assembly 106 in accordance with aspects of this disclosure. FIG. 1c illustrates a second perspective assembly view of the example drainage valve system 100, while FIG. 1d illustrates a perspective cross-sectional view of the example drainage valve system 100 taken along cutline A-A (FIG. 1c).

The valve assembly 106 of the drainage valve system 100 is configured to provide one-way fluid flow through a component opening 104 in the component 102. In the various examples, the component opening 104 is illustrated as a circular opening, but other shapes and configurations are contemplated. The valve assembly 106, therefore, operates as a check valve to enable fluid to, for example, exit a volume via the component opening 104, while prohibiting fluid from entering the volume via the component opening 104. The valve assembly 106 defines a fluid passageway 138 that permits fluid 140 to flow therethrough.

As illustrated in FIGS. 1a and 1b, the component 102 includes, defines, or otherwise provides the component opening 104, illustrated as a circular hole sized to receive at least a portion of the valve assembly 106. The component opening 104 is configured to receive and securely engage the valve assembly 106.

Depending on the application, the component 102 may be fabricated from materials such as metal (or metal alloy), synthetic or semi-synthetic polymers (e.g., acrylonitrile butadiene styrene (ABS), polyvinyl chloride (PVC), etc.), composite materials (e.g., fiberglass), or a combination thereof. In one example, the component 102 is an automotive panel. The component 102 may be a component of a vehicle, such as a battery housing, battery assembly, doors, pillars (e.g., A-pillar, B-pillar, C-pillar), dashboard components (e.g., cross member, bracket, frame), center consoles, fenders, sills, sheet metal framework, or similar parts.

The illustrated valve assembly 106 includes a cap 108 and a valve body assembly 114. To facilitate attachment between the cap 108 and the valve body assembly 114, as well as with the component 102, the valve assembly 106 comprises one or more attachment features. In the illustrated example, the one or more attachment features include one or more cap-locking tabs 154 and one or more component-locking tabs 142. The cap 108 is coupled to the valve body assembly 114 via the one or more cap-locking tabs 154, while the valve body assembly 114 includes or defines the one or more component-locking tabs 142 configured to attach to the component 102. Specifically, the illustrated valve assembly 106 includes four component-locking tabs 142, each having a clip feature 110, and four cap-locking tabs 154, each having a clip feature 148 (and, in some cases, an ingress shield 150).

Each component-locking tab 142 can include a fastener release pocket 164 to enable the clip feature 110 to be disengaged from the component 102 (e.g., to facilitate removal of the valve assembly 106). The component-locking tabs 142 can be disengaged via, for example, a tool used to manipulate the clip feature 110 to flex it via the fastener release pocket 164.

The valve housing 162 can include a plurality of contact pads 152 configured to abut or otherwise contact the cap 108 when assembled, thereby mitigating wobble and movement therebetween. As illustrated, the contact pads 152 extend from the valve housing 162 in the same direction as the cap-locking tabs 154. In the illustrated example, four contact pads 152 are provided, with one positioned between each of the cap-locking tabs 154 to stabilize the cap 108 relative to the valve housing 162.

The four component-locking tabs 142 are illustrated as being distributed 90 degrees about the central axis 136, and the four cap-locking tabs 154 are illustrated as being distributed 90 degrees about the central axis 136. While four of each are illustrated, additional or fewer locking tabs may be used depending on the design requirements (e.g., size, retention strength, etc.).

Each of the illustrated cap-locking tabs 154 comprises a clip feature 148 and an ingress shield 150. The clip feature 148 is configured to connect (e.g., snap) with a corresponding feature formed on the cap 108. For example, the clip feature 148 can engage a ledge 166 formed in a fastener opening 176 defined by a surface of the cap 108, thereby securing the cap 108 to the valve body assembly 114.

The component-locking tabs 142, which can define integrally molded clip features 110, are designed to engage and secure within the edge or perimeter of the component opening 104 of the component 102. To install the valve assembly 106, referring to FIGS. 1a and 1b, the valve assembly 106 is first aligned with the component opening 104. Then, the attachment features of the valve assembly 106 are inserted into the component opening 104 linearly as indicated by arrow 112 until the clip features 110 engage and secure the component opening 104. While a linear “click-based” installation is described, in other examples, the valve assembly 106 can engage and secure within the component opening 104 via a quarter-turn rotational motion (e.g., a 90-degree twist-and-turn motion) or other fractional rotational motion (e.g., a 10- to 45-degree twist-and-turn motion).

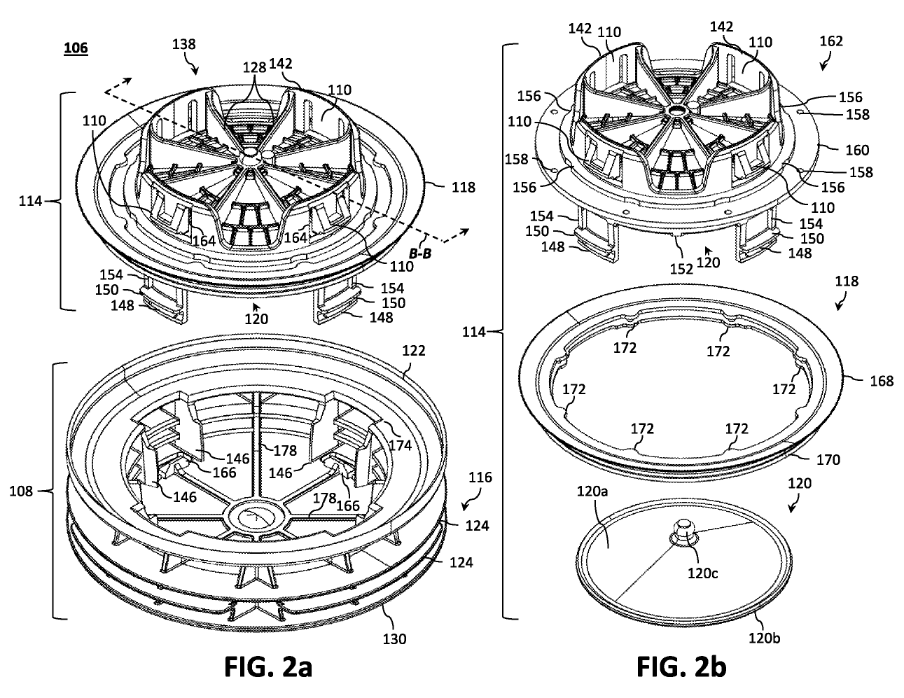

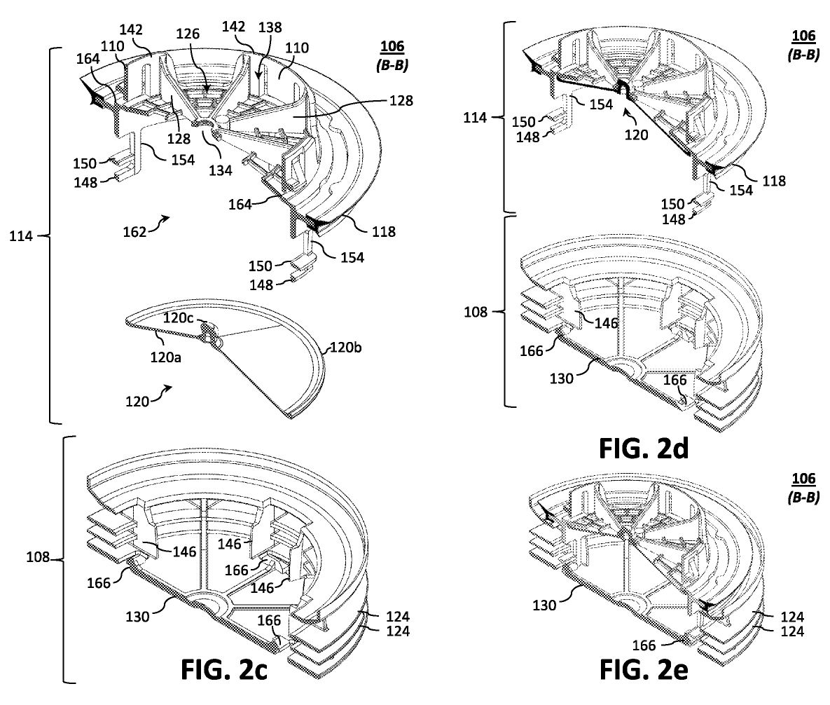

FIG. 2a illustrates a perspective assembly view of the valve assembly 106 with the cap 108 separated from the valve body assembly 114, while FIG. 2b illustrates a perspective assembly view of the valve body assembly 114 having a valve housing 162, seal element 118, and flapper 120. FIGS. 2c and 2d illustrate cross-sectional assembly views of the valve assembly 106 taken along cutline B-B (FIG. 2a) with, respectively, the cap 108 and flapper 120 separated from the valve housing 162, and the cap 108 separated from the valve body assembly 114. FIG. 2e illustrates a cross-sectional assembled view of the valve assembly 106 along cutline B-B (FIG. 2a).

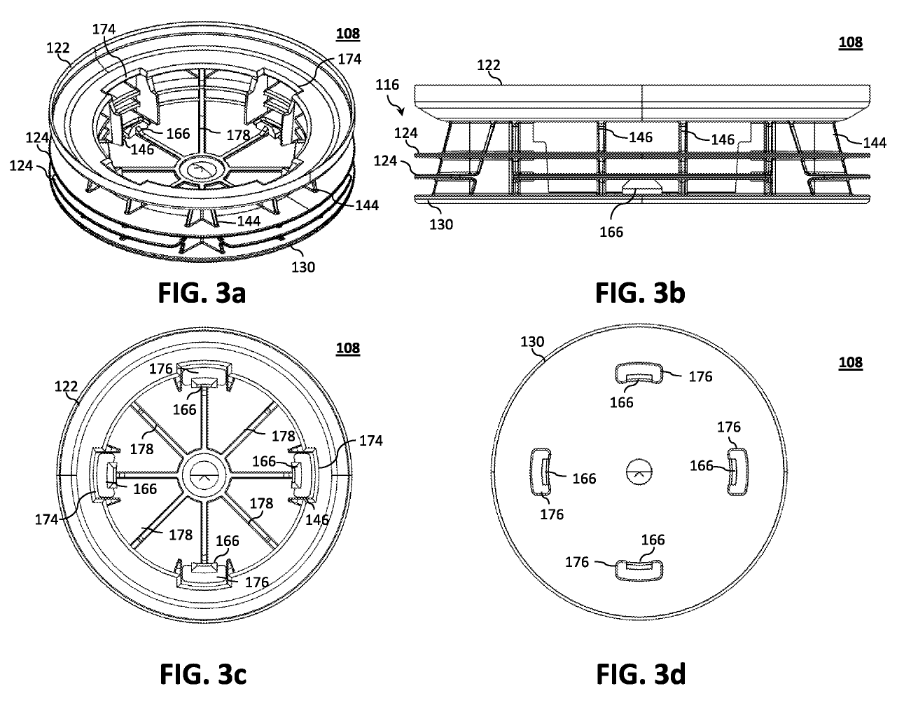

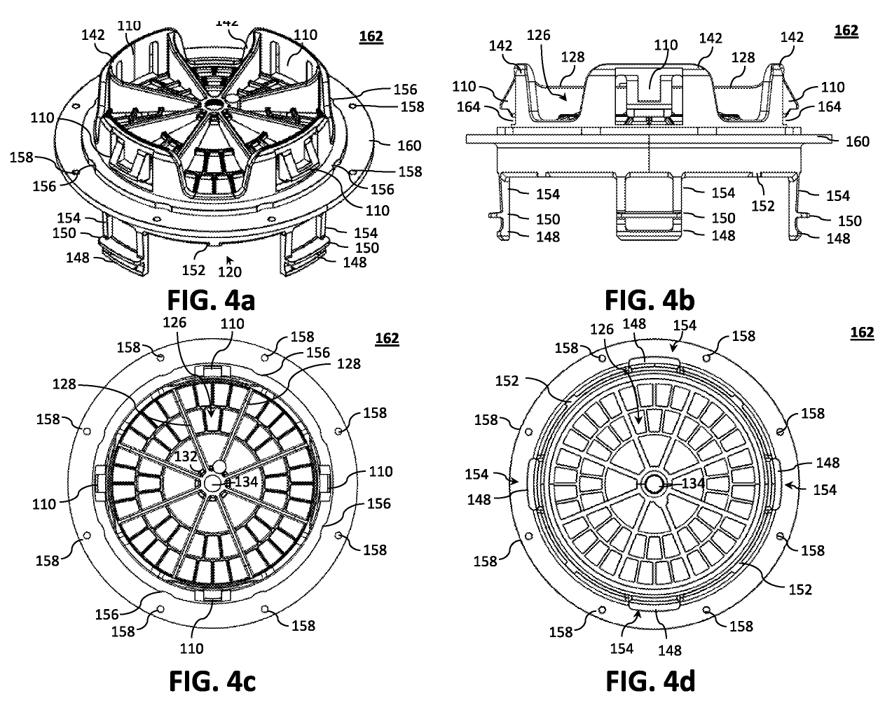

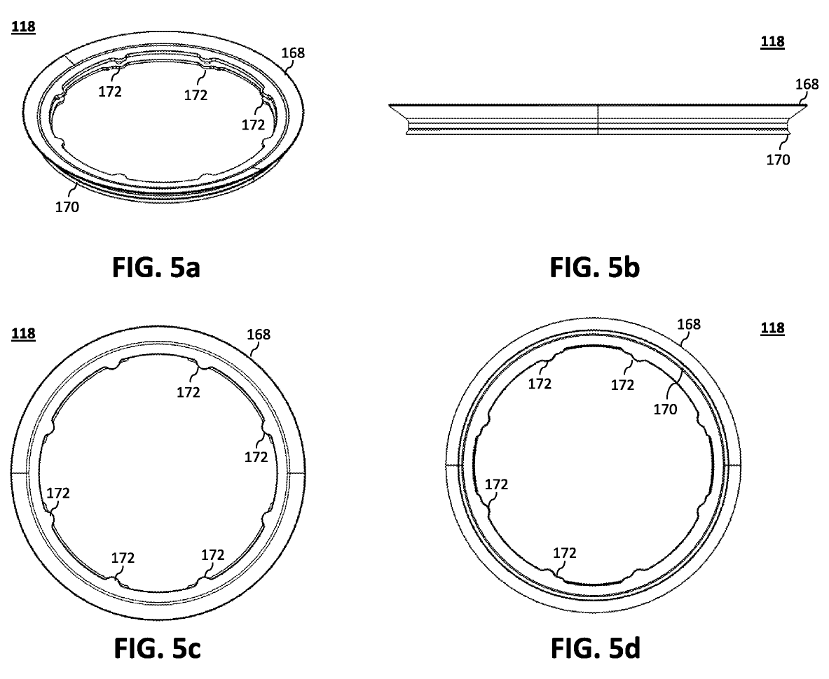

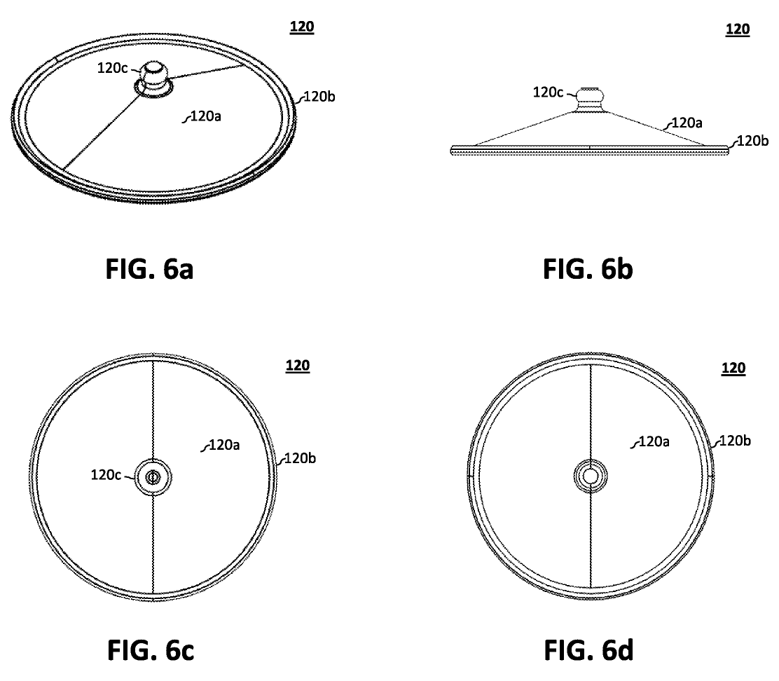

The illustrated valve assembly 106 comprises the cap 108 and the valve body assembly 114. The valve body assembly 114 generally comprises the valve housing 162, a seal element 118 (illustrated as an annular seal), and the flapper 120. FIGS. 3a-3d, 4a-4d, 5a-5d, and 6a-6d illustrate detailed views of the cap 108, valve housing 162, seal element 118, and flapper 120. Specifically, FIGS. 3a-3d illustrate, respectively, perspective, side elevation, top plan, and bottom plan views of the cap 108 of the valve assembly 106. FIGS. 4a-4d illustrate, respectively, perspective, side elevation, top plan, and bottom plan views of the valve housing 162 of the valve assembly 106. FIGS. 5a-5d illustrate, respectively, perspective, side elevation, top plan, and bottom plan views of the seal element 118 of the valve assembly 106. FIGS. 6a-6d illustrate, respectively, perspective, side elevation, top plan, and bottom plan views of the flapper 120 of the valve assembly 106.

The valve housing 162 can further incorporate or define a rigid support mesh 126. The rigid support mesh 126 can be positioned within the fluid passageway 138 of the valve housing 162 and configured to provide structural support for the flapper 120 when it is installed. The rigid support mesh 126 can be integrally formed with the valve housing 162 (as illustrated) or formed separately and coupled thereto. As illustrated, the rigid support mesh 126 defines a flap frame 132 that includes a pin receiver 134. The flap frame 132 and the pin receiver 134 can be positioned at a center of the rigid support mesh 126 to facilitate securement (e.g., a secured attachment) of the flapper 120. For example, the flap frame 132 and the pin receiver 134 can be concentric about the central axis 136. While illustrated as having the flap frame 132 at the center, the flap frame 132 can be omitted and the pin receiver 134 can be formed in a different portion of the valve assembly 106 and/or the rigid support mesh 126.

The flapper 120 comprises a conical body 120a, which can be configured for fluid dynamics and sealing efficiency. As illustrated, the conical body 120a can complement the surface contours of the rigid support mesh 126. A sealing lip 120b can be positioned along the perimeter of the base (wide portion) of the conical body 120a. The sealing lip 120b is configured to make or maintain continuous, firm contact with the perimeter of the fluid passageway 138, thereby ensuring a reliable fluid-tight seal. The attachment mechanism of the flapper 120 includes an attachment pin 120c, which is configured to engage securely with the pin receiver 134 in the rigid support mesh 126. The conical body 120a, the sealing lip 120b, and the attachment pin 120c can be integrally formed with the flapper 120 (as illustrated) or formed separately and coupled thereto. Accordingly, the flapper 120 can be fabricated as a single component from a single material or from multiple components (and, optionally, of multiple, different materials).

The design of the attachment pin 120c includes a bulbous head, which reduces the risk of the attachment pin 120c pulling out of the pin receiver 134 under operational stresses (e.g., fluidic pressure). This bulbous head enhances the retention strength, ensuring the flapper 120 remains firmly in place, thus maintaining the integrity of the seal within the valve housing 162. In practice, to form the connection, the attachment pin 120c of the flapper 120 is pushed through the pin receiver 134 (via the flap frame 132). The attachment pin 120c (e.g., the bulbous head) is sufficiently malleable to compress and/or deform to pass through the pin receiver 134.

The illustrated cap 108 generally comprises a cap surface 130 and a plurality of rings 124 that generally define a sidewall 116. In the illustrated example, the cap 108 further comprises a seal wall 122 configured to cover and protect the seal element 118 (as illustrated in Detail A of FIG. 1d), thereby shielding the sealing interface from direct exposure to physical interaction, debris, and fluid ingress.

The cap surface 130, the plurality of rings 124, and the seal wall 122 collectively serve to protect the valve body assembly 114 from physical damage and obstruction, while also allowing fluid to flow therethrough. The cap surface 130 covers the valve body assembly 114 (e.g., its top or bottom), while the rings 124 protect lateral portions of the valve body assembly 114. The cap surface 130 can comprise a plurality of ribs 168 to increase rigidity, thereby serving as stiffeners to reinforce the cap 108.

The plurality of rings 124 are spaced apart to form gaps or spacings that allow fluid to flow through the sidewall 116 of the cap 108. In the illustrated example, the plurality of rings 124 are spaced apart via support and protection ribs 144, which maintain spacing and structural integrity of the cap 108.

To facilitate attachment of the cap 108 with the valve body assembly 114, the cap surface 130 defines a plurality of fastener openings 176, each having a ledge 166 formed therein. During assembly, the cap-locking tabs 154 of the valve housing 162 can be aligned between fastener guide walls 146 formed on the cap 108, which serve to guide the clip features 148 formed at the ends of the cap-locking tabs 154 toward and into engagement with the ledges 166. Upon full assembly, the ledges 166 and clip features 148 then snap together to secure the cap 108 to the valve housing 162.

One or more of the rings 124 and/or the cap surface 130 can define a fastener clearance notch 174 between the guide walls 146 to allow the cap-locking tabs 154 of the valve housing 162 to more easily pass between and along the guide walls 146 to ultimately engage the ledges 166 during installation of the cap 108 during assembly.

As illustrated in Detail A of FIG. 1d, upon assembly, the ingress shield 150 is configured to align with one of the rings 124 of the cap 108 (or another component, depending on the ultimate design) and is configured to at least partially obstruct or otherwise block the area (e.g., open area) formed between the guide walls 146 by the clearance notch 174, thus mitigating ingress of fluid, debris, or contaminants through the cap 108.

The seal element 118 is positioned around the perimeter of the valve assembly 106. The seal element 118 is designed to ensure a fluid-tight seal between the valve assembly 106 and the component 102 (e.g., at, in, or adjacent to the component opening 104) and between the valve assembly 106 and the cap 108, thus mitigating fluid leakage. The sealed fit between the valve assembly 106 and each of the component opening 104 and the cap 108 also mitigates unintentional dislodgment. As illustrated, the seal element 118 comprises a component-seal lip 168 and a cap-seal lip 170. As illustrated in Detail A of FIG. 1d, upon assembly, the component-seal lip 168 forms a seal between the component 102 and the seal collar 160, while the cap-seal lip 170 forms a seal between the cap 108 and the seal collar 160.

The valve housing 162 and the cap 108 can be fabricated from one or more rigid materials, such as synthetic or semi-synthetic polymers (e.g., acrylonitrile butadiene styrene (ABS), polyvinyl chloride (PVC), etc.), composite materials (e.g., fiberglass), or a combination thereof using plastic injection techniques, additive manufacturing, or other methods. In some examples, the valve housing 162 and the cap 108 may be fabricated using material extrusion (e.g., fused deposition modeling (FDM), stereolithography (SLA), selective laser sintering (SLS), material jetting, binder jetting, powder bed fusion, directed energy deposition, VAT photopolymerization, or other additive manufacturing/3D printing processes). In other examples, the valve assembly 106 can be fabricated from a metal (or a metal alloy).

The seal element 118 can be over-molded or otherwise affixed to the valve housing 162 in a fixed position, while the flapper 120 is configured to move or flex relative to the valve housing 162. The seal element 118 and flapper 120 can be fabricated from one or more flexible and/or pliable materials. The flapper 120 is configured to fluidically seal the fluid passageway 138 within the valve housing 162 and, in some examples, can be biased toward or away from the fluid passageway 138 to control flow therethrough.

The seal element 118 and/or flapper 120 may be fabricated from a foam material, thermoplastic, rubber materials, or combinations thereof. Example thermoplastics include polyethylene (PE) and polyvinyl chloride (PVC), among others. The seal element 118 can be over-molded and/or formed through a two-shot (2K) process with the valve housing 162. Alternatively, the seal element 118 and/or the flapper 120 can be formed through a die-cutting process and positioned on the valve housing 162. For instance, the seal element 118 can be formed separately and then overlaid, adhered, or otherwise positioned on the valve housing 162, while the flapper 120 can be formed separately and attached mechanically (e.g., via the attachment pin 120c).

The valve housing 162 is designed with the rigid support mesh 126 integrated into or positioned within its fluid passageway 138. The rigid support mesh 126 can be supported at least in part by a plurality of walls 128. In the illustrated example, the plurality of walls 128 are configured to provide enhanced stability of the rigid support mesh 126 within the fluid passageway 138. Each of the plurality of walls 128 is attached to an outer perimeter of the valve housing 162 and extends toward the central axis 136. In the illustrated example, the plurality of walls 128 converge about the central axis 136 and form the flap frame 132. In the illustrated example, eight walls 128 extend radially from the flap frame 132 to one or more respective component-locking tabs 142. The illustrated walls 128 divide the fluid passageway 138 into eight circular sectors, as illustrated in FIGS. 4c and 4d.

The valve housing 162 includes a seal collar 160, which serves as the interface between the valve housing 162 and the seal element 118. The seal collar 160 can provide a surface having a series of holes, dimples, angular features, and valleys. In the illustrated example, the seal collar 160 provides a plurality of recesses 156 (e.g., notches) and a plurality of seal-interlock openings 158 about the perimeter.

The intricate surface provided by the plurality of recesses 156 results in a corresponding surface pattern 172 formed on the interior side of the seal element 118 during, for example, the manufacturing process. Similarly, the seal-interlock openings 158 allow the material of the seal element 118 to flow through the seal collar 160 during manufacturing, thereby mechanically interlocking the seal element 118 with the valve housing 162, which also avoids shifting of the seal element 118 relative to the seal collar 160.

The plurality of recesses 156 and the plurality of seal-interlock openings 158 serve to enhance the contact area between the seal element 118 and the valve housing 162. The increased surface area at the interface improves the attachment strength of the seal element 118, resulting in a more secure and durable connection, which is further protected by the cap 108 once assembled.

As can be appreciated, the valve body assembly 114 incorporates the rigid support mesh 126 and couples to the flapper 120 to permit one-way fluid flow through the valve assembly 106. The flapper 120 is configured to permit one-way fluid flow through the fluid passageway 138 by blocking the fluid passageway 138 when fluid flow urges the flapper 120 against the rigid support mesh 126, and by opening (i.e., venting or draining) the fluid passageway 138 when fluid flow urges the flapper 120 away from the rigid support mesh 126.

The rigid support mesh 126 structurally supports the flapper 120 and comprises the plurality of walls 128 that divide the fluid passageway 138 into a plurality of regions - illustrate as eight regions. Each region can be further divided into a grid of mesh openings (illustrated as generally quadrilateral openings, specifically trapezoidal or pie slices) using a first plurality of ribs arranged transverse to a second plurality of ribs. Each mesh opening can be further subdivided into a smaller grid of flow openings as desired. The valve assembly 106 generally defines the fluid passageway 138 through which fluid can flow, while the rigid support mesh 126 is positioned within the fluid passageway 138 to provide structural support to the flapper 120 and maintain the integrity of the valve assembly 106, with the cap 108 enclosing and protecting the assembly while permitting controlled fluid ingress and egress.

The valve assembly 106 is designed to vent various fluids, including gases and liquids, ensuring reliable performance in different applications. The rigid support mesh 126 within the fluid passageway 138 provides a support structure for the flapper 120, which increases overall durability and effectiveness of the valve assembly 106.

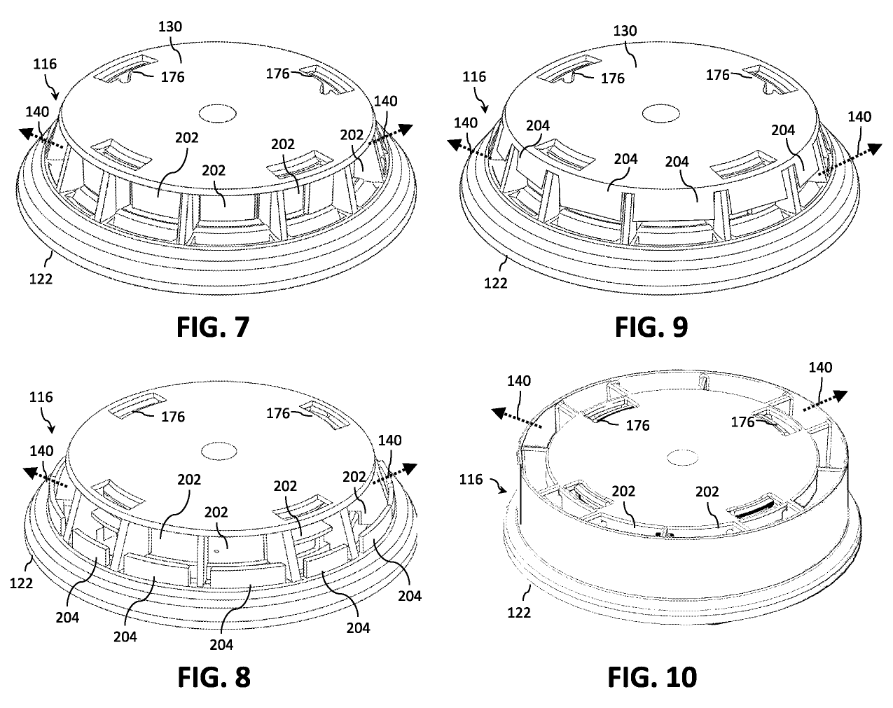

FIGS. 7-10 illustrate alternative cap configurations in accordance with additional examples for use with the valve assembly 106. While the cap 108 described above utilizes the plurality of rings 124 and support ribs 144 to define exit flow paths and provide protection, other configurations of the cap 108 are contemplated to tailor flow characteristics and protective features.

With reference to FIG. 7, the cap 108 is configured as a high-flow cap with an outer protection face, wherein a plurality of windows 202 are distributed about the perimeter of the cap 108 (i.e., along the sidewall 116) to permit increased lateral fluid flow while maintaining structural integrity.

With reference to FIG. 8, the cap 108 is configured as a flow cap with lower sidewall protection, wherein the plurality of windows 202 are similarly distributed about the perimeter, and a plurality of plates 204 extend upward from the seal wall 122 toward the cap surface 130. The plates 204 are generally vertical and flat, providing shielding near the lower portion of the sidewall 116 while still allowing fluid to pass through the windows 202.

With reference to FIG. 9, the cap 108 is configured as a flow cap with upper sidewall protection, wherein the plurality of windows 202 are again distributed about the perimeter, and the plurality of plates 204 extend downward from the cap surface 130 toward the seal wall 122. As with the previous example, the plates 204 are generally vertical and flat, but are positioned to provide protection closer to the upper portion of the cap 108.

With reference to FIG. 10, the cap 108 is configured to provide full sidewall 116 protection, wherein the perimeter of the cap 108 is substantially solid, and the plurality of windows 202 are instead distributed about the perimeter of the cap surface 130 to permit fluid flow while maximizing sidewall shielding. These alternative configurations of the cap 108 demonstrate that the arrangement and location of flow openings and protective structures may be varied while maintaining compatibility with the valve housing 162 and overall functionality of the valve assembly 106.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the implementations disclosed. Instead, the present method and/or system will include all implementations falling within the scope of the appended claims, both literally and under the doctrine of equivalents.

1. A valve assembly, comprising:
a valve housing defining a passageway and including a seal element disposed about at least a portion of the valve housing;
a flapper coupled to the valve housing configured to permit one-way fluid flow through the passageway; and
a cap coupled to the valve housing, the cap at least partially enclosing the valve housing and the flapper and defining one or more openings to permit fluid flow therethrough,
wherein the cap is coupled to the valve housing via one or more cap-locking tabs extending from the valve housing and configured to engage corresponding features of the cap.

2. The valve assembly of claim 1, wherein the cap defines a plurality of fastener openings configured to receive the cap-locking tabs.

3. The valve assembly of claim 2, wherein each of the plurality of fastener opening includes a ledge configured to engage a corresponding clip feature of a respective cap-locking tab.

4. The valve assembly of claim 3, wherein the cap further comprises one or more guide walls positioned adjacent the fastener openings and configured to guide the cap-locking tabs into engagement with the ledges.

5. The valve assembly of claim 4, wherein the guide walls define a channel therebetween configured to align the cap-locking tabs during assembly.

6. The valve assembly of claim 2, wherein the cap further defines at least one clearance notch to facilitate insertion of the cap-locking tabs.

7. The valve assembly of claim 1, wherein the cap further comprises a cap surface and a plurality of rings extending from the cap surface.

8. The valve assembly of claim 7, wherein the plurality of rings is spaced apart from one another to define fluid flow paths through the cap.

9. The valve assembly of claim 7, wherein the plurality of rings are interconnected by a plurality of support ribs.

10. The valve assembly of claim 7, wherein the cap surface includes a plurality of ribs configured to increase structural rigidity of the cap.

11. The valve assembly of claim 1, wherein the cap further comprises a seal wall extending from a cap surface and configured to at least partially cover the seal element.

12. The valve assembly of claim 11, wherein the seal wall is configured to shield the seal element from direct exposure to fluid and debris entering through the cap.

13. The valve assembly of claim 1, wherein the cap is configured such that, upon coupling to the valve housing, the cap cooperates with the seal element to form a fluid-tight interface.

14. The valve assembly of claim 1, wherein the cap is configured to engage the valve housing such that relative axial movement between the cap and the valve housing is restrained by engagement between the cap-locking tabs and the corresponding features of the cap.

15. The valve assembly of claim 1, wherein the cap is further configured to engage the valve housing such that relative rotational movement between the cap and the valve housing is restrained.

16. The valve assembly of claim 1, wherein at least one of the cap-locking tabs includes an ingress shield configured to align with a portion of the cap to block an opening formed in the cap.

17. The valve assembly of claim 16, wherein the ingress shield is configured to obstruct a clearance notch defined in the cap when the cap is coupled to the valve housing.

18. The valve assembly of claim 1, wherein the cap is configured to be coupled to the valve housing by a snap-fit engagement.

19. The valve assembly of claim 1, wherein the cap is configured to be removable from the valve housing without destruction of either component.

20. The valve assembly of claim 1, wherein the cap is configured to enclose the valve housing while permitting fluid flow through openings defined between structural elements of the cap.
